(19) United States
(12) Patent Application Publication
(10) Pub. No.: US 2026/0290879 A1
(43) Pub. Date: Sep. 24, 2026

(54) Electrochemical Storage Cell Having a Compression Device for Compensating an Expansion of Stacked Accumulator Cells in a Stacking Direction

(71) Applicant: Bayerische Motoren Werke Aktiengesellschaft, Muenchen (DE)

(72) Inventors: Simon ERHARD, Geltendorf (DE); Attila FARKAS, Muenchen (DE)

(21) Appl. No.: 19/476,524

(22) PCT Filed: Apr. 9, 2024
(86) PCT No.: PCT/DE2024/100294

§ 371 Date: Oct. 17, 2025

(30) Foreign Application Priority Data
May 8, 2023 (DE) 10 2023 111 870.6

(51) Int. Cl. H01M 10/04; H01M 10/0525; H01M 50/107

(52) U.S. Cl. CPC H01M 10/0468; H01M 10/0525; H01M 50/107

(57) ABSTRACT

An electrochemical storage cell has a compression device for compensating an expansion of an electrode stack in a stacking direction. The storage cell comprises the electrode stack, which is arranged in a housing, and the compression device. The compression device is configured to exert a compression pressure on the electrode stack, and the compression pressure is imparted by way of rotational movement about the stacking direction. The compression pressure is adjustable depending on a rotational position. The electrode stack is substantially decoupled from the rotational movement of the compression device.

### BACKGROUND AND SUMMARY

The following description relates to an electrochemical storage cell having a compression device for compensating an expansion of stacked electrochemical storage cells in a stacking direction. Also described is a storage cell module having electrochemical storage cells.

### PRIOR ART

Solid-state batteries are a particular type of accumulator battery in which the electrodes and the electrolyte are composed of solid material. Solid-state batteries are increasingly being viewed as an important building block for the electrification of mobility. They are considered safer and enable a greater range and shorter charging times than conventional lithium-ion batteries.

A known problem with solid-state batteries and other structural forms relates to variable layer thicknesses. For example, in anode-free all-solid state batteries (ASSB), no anode is initially realized on the anode side in the discharged state, but only a current collector (e.g. a copper foil) is present. In the charged state, an anode is realized in the form of pure lithium, which migrates from the cathode (lithium is stored in the cathode) through a separator during the charging process and is deposited or formed on the copper foil. To put the cell into operation, the electrode layers must be compressed. The forces required are in the kN range, and the pressures in the double-digit bar range.

The prior art offers solutions to these problems. However, it remains a technical challenge to keep the compression forces or pressures within certain limits once they have been set, in particular in the case of electrode stacks of variable heights. For example, if the forces in the cell are designed for a charged state, the corresponding forces in the intermediate states between a charged and a discharged state would be too low. The cell would not be able to function properly. If the forces in the cell are designed for the discharged state, the compression forces or pressures in the intermediate states between the charged and discharged states would be too high. The cell could burst.

Constant compression of the layers of an electrode stack may be achieved by active or passive pneumatic or hydraulic systems. However, this means, for example, that either all cells must be supplied by one pressure unit or corresponding modules having a plurality of cells must each be supplied by one pressure unit. This is complex and requires a lot of space, for example in order to compensate the expansion of individual cells or of a plurality of cells in the module. A hydraulic system must be continuously supplied with energy in order to keep the pressing forces constant even during extended periods of inactivity. Hydraulic systems can be prone to leaks, and a pipework system also requires space.

An object is to specify an electrochemical storage cell that can be operated with a compression pressure that is easier to set and maintain. Also to be specified is a storage cell module composed of such electrochemical storage cells.

This object may be achieved by an electrochemical storage cell and a storage cell module according to the independent and subordinate claims. Advantageous embodiments and developments are given by the dependent claims.

### SUMMARY

It is understood in the following that any feature described with respect to any embodiment may be used alone or in combination with other features described herein, and may be used in combination with one or more features of any other embodiment, or in any combination of any other embodiment, unless explicitly described as an alternative. Moreover, equivalents and modifications not described below may be used without departure from the scope of the claimed subject-matter.

In the following, an electrochemical storage cell denotes an electrochemical-based energy store, in particular a rechargeable energy store, that is suitable for storing electrical energy and discharging it to a consumer, for example a consumer in a vehicle. An electrochemical solid-state cell is a solid-state battery such as, for example, a lithium-ion battery, such that the following description also relates to a lithium-ion solid-state battery. A solid is to be understood to be a chemical substance that is rigid at the temperatures normally prevailing in an electrochemical storage cell, or that at least has a very low propensity to flow, as may be the case, for example, with polymers.

In the following, the term “lithium-ion battery” is used synonymously for all terms commonly used in the prior art for lithium-containing galvanic elements and electrochemical storage cells, such as, for example, lithium battery, lithium cell, lithium-ion cell, lithium-ion polymer cell, lithium-ion battery cell and lithium-ion accumulator battery. In particular, rechargeable batteries, so-called secondary batteries, are included. The terms “battery” and “electrochemical storage cell” are also used synonymously with the terms “lithium-ion battery” and “lithium-ion cell.”

The term “electrode stack” denotes a sequence of layers or foils. In an electrochemical storage cell, the layers are arranged in succession. However, this does not mean that the layers specified here must be arranged in direct succession. Rather, intermediate layers may also be provided, such as, for example, a separator, insulator, electrode binder, coatings and electrical conductivity additives that may be applied to an electrically conductive carrier of the respective electrodes.

An electrochemical storage cell typically has different electrodes, a positive electrode (cathode) and a negative electrode (anode), which may be electrically contacted via current collectors. Each of these electrodes has at least one active material, optionally together with additives such as electrode binders and electrical conductivity additives, that are applied to an electrically conductive carrier (for example a metal foil) or to a current collector of the respective electrodes. Non-porous and solid conductive foils made of aluminum (for the positive electrode) or copper (for the negative electrode) are typically used as the electrically conductive carrier. Such conductive foils are typically impermeable to liquid electrolyte and gases. The electrochemical storage cells described below may be used with a liquid electrolyte or designed with a solid electrolyte as electrochemical solid-state storage cells, for example as a ceramic or polymer-based solid-state battery. A solid-state electrochemical cell comprises a solid electrolyte.

Furthermore, an electrochemical storage cell having a compression device for compensating an expansion of an electrode stack in a stacking direction is proposed.

According to one embodiment of the invention, the electrochemical storage cell comprises the electrode stack, arranged in a housing, and the compression device. The compression device is configured to exert a compression pressure upon the electrode stack by way of a rotational motion about the stacking direction. The compression pressure is adjustable based on a rotational position. The electrode stack is substantially decoupled from the rotational motion of the compression device. The electrode stack is substantially stationary irrespective of the rotational position of the compression device.

The electrochemical storage cell may be arranged in a round housing (as a round cell). The housing is cylindrical, for example, and has a circular cross-section. The further components, in particular the electrode stack. in the housing may preferably also have a circular cross-section. The electrode stack may be mixed with a liquid electrolyte, or the electrode stack may be provided with a solid electrolyte, which is incorporated into the layer sequence of the electrode stack. In this way, an electrochemical solid-state storage cell (all-solid-state battery or ASSB for short) can be formed.

A compression pressure upon the electrode stack may be set when the electrochemical storage cell is in operation. This is effected by a rotational motion at the compression device. Due to the decoupling of the compression device from the electrode stack, the rotary motion does not act directly upon the electrode stack. The compression pressure can act upon the electrode stack in the stacking direction. The rotational motion is converted into a translational motion by the compression device. This has the effect that the electrode stack does not rotate concomitantly with the compression device. In this way, there are no shearing forces that could damage or destroy the electrode stack. The compression device thus allows easy setting of the compression pressure. Furthermore, the compression pressure can be maintained substantially without energy and without difficulty.

The technology is based in particular on the considerations set out below. One aspect is aimed at ensuring the most constant possible compression of the electrodes of an electrode stack in the different states of charge. One solution relates to a compression device that can compensate expansion in front of stacked electrodes of the electrochemical storage cell in the stacking direction, for example by steplessly readjusting a change in the layer height without energy being required to maintain this state in a particular state of charge of the storage cell. Energy may be expended if the layer thickness needs to be readjusted, for instance in order to keep compression forces within certain threshold values. Basically, the electrochemical storage cell may be constructed like a screw. When the screw is tightened, pressure is generated; when the screw is unscrewed, the pressure is relieved. Additionally, the screw may be readjusted as required. This may be ascertained in advance in a laboratory.

The proposed electrochemical storage cell can be compared to a “lipstick,” whereby the underside may be driven by an actuating drive that drives a cell or a row of cells or even a module. Depending on the direction of motion of the actuating drive, the electrodes are “compressed” or “relieved” (“compressed”: the cell discharges; “relieved”: the cell is charged, for example the anode layers are formed depending on the state of charge). In order not to concomitantly rotate the electrodes and possibly destroy the layers of the electrode stack, the electrode stack is decoupled via the compression device, such that the electrodes can only be compressed, but substantially no torsion acts upon the electrode stack as a result of the rotational motion of the compression device.

According to one embodiment, the compression device comprises a threaded adapter that is mechanically connected to the housing. A screw connection element is configured for setting the rotational position of the compression device, wherein the screw connection element can be screwed to the threaded adapter. The compression device further comprises, arranged between the electrode stack and the screw connection element, a needle-roller and cage thrust bearing, which is configured to decouple the rotational motion about the stacking direction from the electrode stack.

The screw connection element may be screwed into or out of the threaded adapter, thereby increasing or decreasing the compression pressure. Due to the screw nature of the screw connection element, the compression pressure can remain at a set value without the need for expenditure of additional energy. The needle-roller and cage thrust bearing is rotated by the screw connection element, but does not transmit the rotational motion to the electrode stack, from which it is decoupled. A propulsion is thus created, imparted by the rotational position of the screw connection element, which exerts the compression pressure upon the electrode stack as a translational motion along the stacking direction.

According to one embodiment, the screw connection element has an external thread that can engage in an internal thread of the threaded adapter, such that the screw connection element can be rotated in the threaded adapter. The screw threads enable the screw connection element to be screwed in and out of the threaded adapter.

According to one embodiment, the storage cell comprises a pressure plate. The pressure plate is movable along the stacking direction in the housing and rests, for example, on the needle-roller and cage thrust bearing. The pressure plate is in operative mechanical contact with an underside of the electrode stack and is configured to exert the compression pressure upon the underside of the electrode stack. The pressure plate is moved along the stacking direction by the operative mechanical contact and thus, for example, lies flat on the underside of the electrode stack. The pressure plate thus acts as a plunger that exerts the compression pressure upon the electrode stack.

According to one embodiment, the needle-roller and cage thrust bearing has a rolling-needle cage and rolling needles that can roll freely in rolling regions of the rolling-needle cage. The rolling-needle cage is dimensionally stable under the compression pressure. The needle thrust bearing provides a very stiff bearing arrangement with a small to minimal axial space requirement. Particularly space-saving bearing arrangements are achieved if, as here, the pressure plate can be used as a raceway for the rolling needles.

According to one embodiment, the storage cell comprises a further pressure plate. The further pressure plate is arranged mechanically fixed in the housing, such that the further pressure plate is in operative mechanical contact with an upper side of the electrode stack and is configured to exert a counter-pressure to the compression pressure upon the upper side of the electrode stack. The electrode stack may thus be compressed between the two pressure plates according to the compression pressure in the housing set by the screw connection element.

According to one embodiment, the electrode stack comprises a stack arrangement of successive layers. In a charged state, the stack arrangement comprises at least one cathode layer, at least one anode layer and at least one separator layer arranged between the cathode layer and the anode layer. The anode layer may be completely or partially depleted in a discharged state.

According to one embodiment, the successive layers of the electrode stack are stacked in a stacking direction on an inner tube arranged in the housing. The at least one cathode layer and at least one anode layer are electrically contacted to the housing or to the inner tube.

According to one embodiment, the electrochemical storage cell is designed as a solid-state storage cell and comprises, in particular, a solid electrolyte. In a further embodiment, the electrochemical storage cell comprises a liquid electrolyte or an electrolyte that is liquid under compression pressure and gaseous under standard conditions.

According to one embodiment, the screw connection element has a lateral actuating thread for being engaged by an external actuating drive. The lateral actuating thread may be used by the external actuating drive, for example a motor or stepper motor, to set and/or change the compression pressure. The lateral actuating thread may be implemented as an external thread of the screw connection element or combined with it.

Furthermore, a storage cell module is proposed. According to one embodiment, the storage cell module comprises a plurality of electrochemical storage cells according to any one of the preceding claims. The module also comprises at least one external actuating drive that is configured to drive the compression device in order to exert a compression pressure upon the electrode stack and to set the compression pressure depending on a rotational position. The external actuating drive or drives may be operated by a control unit that adjusts the compression pressure on the electrode stack. For example, the control unit may measure a state of charge of one or more of the electrochemical storage cells, or receive corresponding measurement signals. The operative control of the external actuating drive or drives, and thus the control of the corresponding compression pressure, may thus be effected depending on the states of charge of electrochemical storage cells of the storage cell module. For example, individual cells, rows of cells or modules may be driven/operatively controlled individually. for example by the drive belts on the external actuating drive or a main drive source being engaged or not engaged. For this purpose, a toothed belt may alternately be tensioned and drive the compression device, or not be tensioned and not drive the compression device.

In the following, exemplary embodiments of the technology are described with reference to the accompanying drawings. This provides further details, preferred embodiments and developments. In the figures, component parts that are identical or identical in their effect are in each case denoted the same reference designations. The component parts represented and the proportions of the component parts in relation to one another are not to be regarded as true to scale. Insofar as components and component parts in the various figures correspond in their function, the description thereof is not necessarily repeated for each of the subsequent figures.

In detail, in the drawings:

### BRIEF DESCRIPTION OF THE DRAWINGS

FIGS. 1A to 1D show an exemplary embodiment of an electrochemical storage cell,

FIGS. 2A, 2B show a sectional representation of an exemplary embodiment of an electrochemical storage cell in a charged and a discharged state,

FIGS. 3A, 3B show an external view of the exemplary embodiment of an electrochemical storge cell in a charged and a discharged state,

FIGS. 4A, 4B show an exemplary embodiment of a compression device with an external actuator,

FIGS. 5A, 5B show a further exemplary embodiment of an electrochemical storage cell, and

FIGS. 6A, 6B show an enlarged representation of the exemplary embodiment of an electrochemical storage cell in a charged and a discharged state.

### DETAILED DESCRIPTION OF THE DRAWINGS

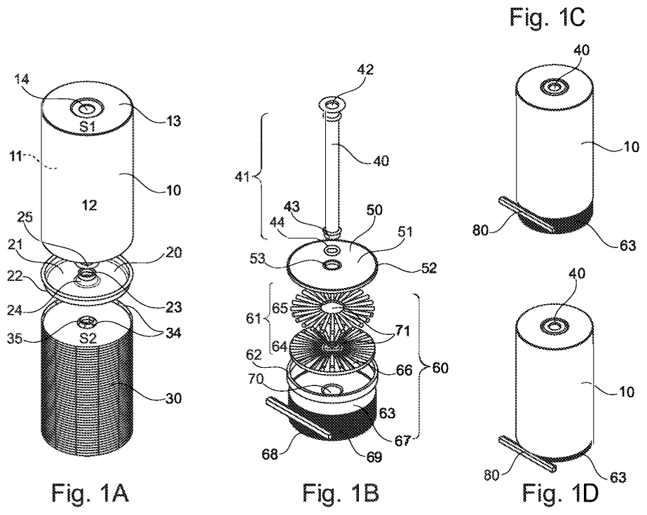

FIGS. 1A to ID show an exemplary embodiment of an electrochemical storage cell. The illustrations show an exploded representation of the electrochemical storage cell, with the representation being divided over FIGS. 1A and 1B and the electrochemical storage cell being represented in the combined view of both figures, as represented in FIG. 1C.

FIG. 1A shows a housing 10, a first pressure plate 20 and an electrode stack 30. In this example, the housing 10 is designed as a round housing, or cylinder, and is made, for example, of metal or another pressure-resistant material. Alternatively, the electrochemical storage cell may also be realized as a prismatic cell, in which case the housing is also constructed from a solid material, usually metal. The housing may have a polygonal cross-section, such as a hexagonal cross-section. The storage cell realized, for example, as a round cell is a storage cell that can be produced economically in terms of cost and time. The round cell enables flat contacting between contacting elements and the respective electrode, which is electrically connected to the respective contacting element. Various further components of the electrochemical storage cell are presented below. Unless explicitly stated, these components have a cross-section that is at least similar to that of the housing, such that the components can be designed so as to be connectable to or movable in the housing. In the case of a round housing, or a round cell, the cross-section is substantially circular.

FIG. 1A shows an external view of the housing 10. The housing delimits an internal receiving space 11 (not shown) that has a circular cross-section and and that can receive an electrode stack 30. The housing comprises a housing shell 12 and a cover 13. On a first side S1, the receiving space is delimited by the cover 13 in the direction of longitudinal extent of the cylindrical housing. In this example, the housing shell 12 and the cover 13 are made from a single piece. Alternatively, the cover 13 may be screwed or otherwise mechanically connected (for example, welded or crimped) to the housing shell 12. The cover 13 also comprises a central cover opening 14, which allows access to the inside of the electrochemical storage cell, for example, in order to insert an inner tube. Further, the cover opening 14 may be used to fill in an electrolyte and/or coolant.

A first pressure plate 20 is shaped to correspond to the cross-section of the housing 10, thus in this example it is substantially circular. The pressure plate 20 comprises a pressure-plate base 21 and a pressure-plate rim 22. The pressure-plate base 21 is configured to rest in a form-fitting manner on an upper side S2 of the electrode stack 30. The pressure-plate rim 22 comprises a wall which extends in the form of a dish along the circumference of the pressure plate and rises from the pressure-plate base 21. Furthermore, the pressure plate 20 has a central pressure-plate opening 23, which substantially coincides with the cover opening 14 and is coaxial therewith. In this example, the pressure-plate opening 23 is structured into a pressure-plate protrusion 24 that can engage in a form-fitting manner in the pressure-plate opening 23. The pressure-plate opening 23 is large enough to receive an inner tube 40, or to enable the inner tube 40 to be passed through the pressure-plate opening 23. Provided for insulation between the inner tube 40 and the housing shell casing 12 there is an insulating ring 25, which may be crimped, for example as a plastic part, to the protrusion 24 with the pressure-plate opening 23, or connected mechanically in another suitable manner.

The first pressure plate 20 is inserted into the housing and permanently connected to it on the housing shell 12, for example by welding, crimping or screwed connection. “Permanently connected” here means that the connection is strong enough to withstand at least the compression pressure with which the electrode stack 30 is compressed. Alternatively, or in addition, the pressure plate 20 may be supported by a rim, or collar, on the cover 13 in order to have a defined dimension. On the first side SI, the dish shape of the pressure plate 20, or the pressure plate rim 22, results in an upper internal cavity being formed between the cover 13 and the pressure-plate base 21.

The electrode stack 30 comprises a plurality of stacks arranged one on top of the other, the respective stack having layers arranged on top of each other, namely at least one cathode layer 31, at least one anode layer 32 and at least one separator layer 33 arranged between the cathode layer 31 and the anode layer 32. Furthermore, the stacks may have further layers such as insulators and metallic conductor foils (for example made of aluminum or copper). The cathode layers 31 and the anode layers 32 are electrically contacted to the inner tube 40 or to the housing shell 12 via corresponding clips 34.

The upper side S2 of the electrode stack 30 engages in a form-fitting manner onto the first pressure plate 20. For example, the pressure-plate base 21 lies substantially over the entire surface of the upper side S2 of the electrode stack. Since the first pressure plate 20 is mechanically fixed to the housing 10, or the housing shell 12, the pressure plate 21 is not movable under pressure.

FIG. 1B shows the inner tube 40, a second pressure plate 50 and a compression device 60. The inner tube 40 is realized separately from the electrode stack 30 and is guided through the electrode stack 30 through a stack opening 35, such that the inner tube is surrounded by the electrode stack 30 in a longitudinal region 41. The inner tube 40 is guided through the electrode stack 30 to such an extent that, by way of a plunger-type upper side 42, it engages in the cover opening 14 of the cover 13. An underside 43 of the inner tube 40 is connected via an O-ring 44 to a central opening 53 of the second pressure plate 50 and sealed by the inner tube 40. The inner tube 40 is arranged along a stacking direction of the electrode stack 30.

The second pressure plate 50 is designed to correspond to the cross-section of the housing 20, thus in this example it is substantially circular. The pressure plate 50 comprises a pressure-plate base 51 and a pressure-plate rim 52. The pressure-plate base 51 is configured to rest on an upper side of the compression device 60. The pressure-plate rim 52 comprises a seal that extends along the circumference of the pressure plate 50 and seals the pressure plate 50 from the housing shell 12, but keeps the pressure plate 50 movable in the stacking direction within the housing 10. Furthermore, the pressure plate 50 has a central pressure-plate opening 53 that is substantially axially coincident with the cover opening 14, such that the inner tube 40 can be guided into the central pressure-plate opening 53 and terminates in this region.

The pressure-plate opening 53 is large enough to receive the inner tube 40, or to enable the inner tube 40 to be passed through the pressure-plate opening 53. The second pressure plate 50 is inserted into the housing 10 and is movable along the housing shell 12 and the inner tube 40.

The compression device 60 is a multi-part device and in this exemplary embodiment comprises a needle-roller and cage thrust bearing 61, a threaded adapter 62 and a screw connection element 63. The needle-roller and cage thrust bearing 61 comprises a rolling-needle cage 64 and rolling needles 65. Needle-roller and cage thrust bearings 61 are rolling bearings that have a particularly low-profile structural form. The rolling needles 65 are rolling elements that may be conical or cylindrical. The needle-shaped profile of the rolling needles 65 is created by a tumbled or slightly ground end face in combination with an elongate peripheral surface. Conical rolling needles 65 are advantageous because comparatively more needles can be used. More needles 65 contribute to better load distribution. The rolling-needle cage 64 and the rolling needles 65 each comprise a central bearing opening 71 and may be made of plastic, metal or a combination of both. The rolling needles 65 are located in rolling regions 66 of the rolling-needle cage 64 and can thus roll freely on the underside of the pressure-plate base 51. The rolling-needle cage 64 is substantially circular and can be inserted into the threaded adapter 62 and thus rest on the screw connection element 63. In this way, the screw connection element 63 and the second pressure plate 50 serve as surfaces on which the rolling needles 65 can roll.

When the electrochemical storage cell is in the assembled state, the circular threaded adapter 62 is connected to the housing 10 in a mechanically stable manner, for example it is welded or crimped to the housing shell 12. In this way, the threaded adapter 62 is fixedly connected to the housing 10. The threaded adapter 62 has an internal thread. The circular screw connection element 63 has an external thread 68 that can engage in the internal thread of the threaded adapter 62. The external thread 68 is, for example, a screw thread (e.g. helical). The thread 68 allows the screw connection element 63 to be rotated, or screwed, into the threaded adapter 62. The screw connection element 63 also has a rotational face 67 that has a central rotational-face opening 70. In the assembled state, the needle-roller and cage thrust bearing 61 rests on the rotational face 67, such that the rolling needles 65 can rotate freely in the rolling-needle cage 64.

The screw connection element 63 also has a lateral actuating thread 69. An external actuating drive 80 can engage in the lateral actuating thread 89 and thus rotate the screw connection element 63. The actuating thread 89 may be a thread that is separate from the external thread 68 and may be arranged, for example, in a lateral region of the screw connection element 63 in which the external thread 68 is not located. Alternatively, as indicated in FIG. 1B, a combination thread may comprise the external thread 68 and the lateral actuating thread 69. For this purpose, for example, the external thread 68 is interrupted by notches along the circumference of the screw connection element 63, such that a threaded rod of the external actuating drive 70 can engage in the notches and thus rotate the screw connection element 63 in the threaded adapter 62.

FIGS. 1C and 1D show the electrochemical storage cell in the assembled state. For this purpose, the component parts, as shown in FIGS. 1A and 1B and described above, are guided into one another. The inner tube 40 serves here as an inner stacking axis that brings the two pressure plates 20, 50, the electrode stack 30 and the compression device 60 together and stacks them on top of each other. For this purpose, the inner tube 40 is guided through the rotational-face opening 70, the bearing opening 71, the pressure-plate opening 53, the stacking opening 35 and the pressure-plate opening 23, which are arranged coaxially along the inner tube 40.

Assembled in this way, compression pressure can be exerted upon the electrode stack 30—by way of the compression device 60—by raising and lowering the pressure plate 50. For this purpose, the screw connection element 63 is turned manually or by the external actuating drive 80. The external thread 68 then engages in the internal thread of the threaded adapter 62, and may be screwed into or out of the threaded adapter 62. The first pressure plate 20 is fixedly connected to the housing casing 12 and thus acts as a stop face (see pressure-plate base 21) against which the electrode stack 30 is pressed when the compression pressure is built up by the compression device by way of the screw connection element 63. The electrode stack 30 is compressed by the corresponding counter-pressure.

FIG. 1C shows an example of a state in which the cell has been unscrewed, and FIG. 1C shows an example of a state in which the cell has been screwed in. Also depicted is the external actuating drive 80, which is indicated as a threaded rod or belt. The screwing-in and unscrewing cause a distance between the rotational face 67 and the second pressure plate 50, or the pressure-plate base 51, to becomes less or greater. The needle-roller and cage thrust bearing 61 can rotate freely in the threaded adapter 62 and against the rotational face 67. The pressure plate 51 can thus be lifted out of a rotational motion of the screw connection element 63, the rotation being converted into a translational motion along the inner tube 40. This is made possible by the rolling needles 65, which move in the rolling-needle cage 64. In this way, it can be ensured that the pressure plate 50 does not transmit any rotational motion, caused by the compression device 60, into the electrode stack 30.

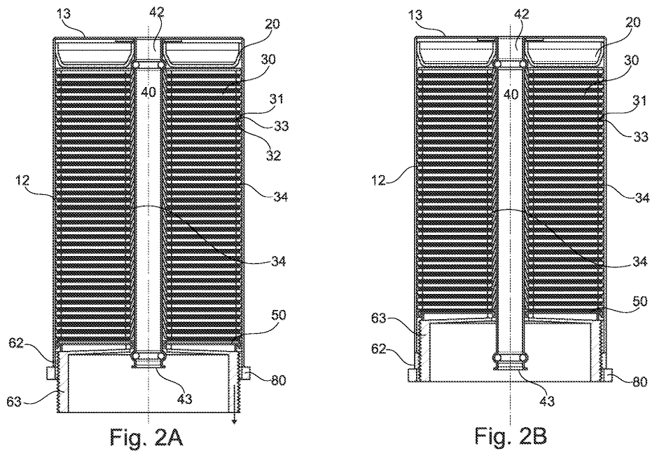

FIGS. 2A and 2B show a sectional representation of an exemplary embodiment of an electrochemical storage cell in a charged and a discharged state. This example corresponds to the exemplary embodiment in the assembled state shown in FIGS. 1A and 1B and described above. In FIG. 2A the storage cell is charged and in FIG. 2B the storage cell is discharged.

The cell is designed, for example, as a solid-state cell, in particular as an anode-free all-solid-state battery (ASSB). The electrode stack 30 shown in section comprises a plurality of stacks arranged on top of each other. A stack has layers arranged on top of each other, namely in each case a cathode layer 31, an anode layer 32 and a separator layer 33 arranged between the cathode layer 31 and the anode layer 32. Furthermore, the stacks may have further layers such as insulators and metallic conductor foils (for example made of aluminum or copper), which are not represented here. The cathode layers 31 and the anode layers 32 are electrically contacted to the inner tube 40 or to the housing shell 12 via corresponding clips 34.

In this example, a lithium battery is considered. Here, the cathode layers 31 have substantially the same layer thickness in the charged state and the discharged state. In contrast, the layer thickness of the anode layers 32 changes depending on the state of charge. In the charged state, anode layers 32 have accumulated. These are realized by the charging process as lithium collects on conductor foils (for example copper foils). The electrode stack 30 grows in height by the thickness of an anode layer 32 x the number of layers. In the discharged state, no anode layer 32 is realized. Lithium is stored in the cathode layers 31. The lithium migrates from the anode layers 32, through the separator layers 33, and into the cathode layers 31 and is stored there.

The different layer thicknesses are indicated in the drawings (see FIG. 2A: the storage cell is charged and FIG. 2B: the storage cell is discharged). In both states, a wanted compression pressure is set, which acts upon the electrode stack 30. This is effected by way of the compression device 60.

In FIG. 2A, the compression device 60 is extended relative to the housing 10. This can be seen in the drawing in that the screw connection element 63 is extended relative to the threaded adapter 62, which is fixed to the housing 10. The pressure plate 50 bears against the underside of the electrode stack 30 and thus imparts the compression pressure to the electrode stack 30. In FIG. 2B, the compression device 60 is retracted relative to the housing 10. This can be seen in the drawing in that the screw connection element 63 is retracted relative to the threaded adapter 62, which is fixed to the housing 10, i.e. it projects further into the housing 10. This can also be seen from the fact that the inner tube 40 protrudes further into the screw connection element 63. The pressure plate 50 thus continues to impart the compression pressure to the electrode stack 30. The external actuating drive 80, which causes the screw connection element 63 to rotate, is also indicated in the drawings. It should be noted that the position of the external actuating drive in relation to the housing 10 remains unchanged.

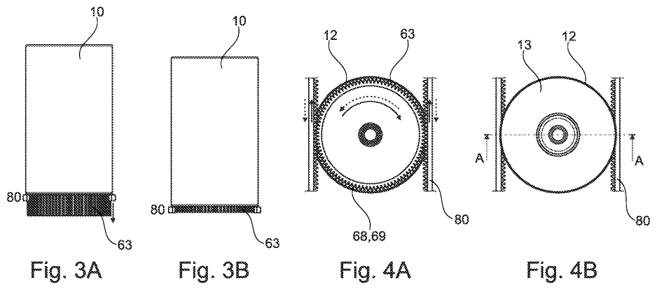

FIGS. 3A and 3B show an external view of the exemplary embodiment of an electrochemical storage cell in a charged and a discharged state. This example corresponds to the exemplary embodiment in the assembled state shown in FIGS. 1A and 1B and described above. In FIG. 3A the storage cell is charged and in FIG. 3B the storage cell is discharged. It can be seen from the drawings how the screw connection element 63 is extended and retracted relative to the threaded adapter 62, which is fixed to the housing 10, i.e. how it projects less or further into the housing 10, depending on the state of charge. It can also be seen how the position of the external actuating drive 80 remains unchanged in relation to the housing 10.

FIGS. 4A and 4B show an exemplary embodiment of a compression device 60 with an external actuating drive 80. FIG. 4A shows a plan view of the cell from below. An underside of the screw connection element 63 can be seen. FIG. 4A shows a plan view of the cell from above. An upper side of the cover 13 can be seen.

In this example, the external actuating drive 80 is double-sided and comprises, for example, two threaded rods or belts. The external actuating drive 80 engages in the external thread 68, or the lateral actuating thread 69, of the screw connection element 63. Moving of the threaded rods or belts effects a rotational motion of the screw connection element 63, which can move the pressure plate 50 up and down along the inner tube 40, as described above, and ultimately sets the compression pressure on the electrode stack 30. Typically, a plurality of electrochemical storage cells are combined to form a battery module. In principle, each electrochemical storage cell may have its own actuating drive. In a battery module, one actuating drive may operate a plurality of electrochemical storage cells. For example, a plurality of electrochemical storage cells may be arranged in a series in such a way that a common threaded rod or a common belt engages in the corresponding external threads 68 or lateral actuating threads 69 of the screw connection elements 63 of the electrochemical storage cells.

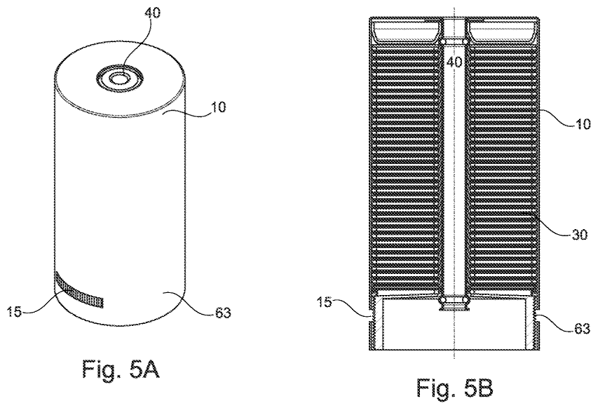

FIGS. 5A and 5B show a further exemplary embodiment of an electrochemical storage cell. This example is a development of the embodiment as represented in FIG. 1A to ID. In contrast, the screw connection element 63 of the electrochemical storage cell is implemented inside the housing 10. The external thread 68 or the lateral actuating thread 69 of the screw connection element 63 is accessible through a lateral housing opening 15. The external actuating drive 80 thus engages in the external thread 68, or in the lateral actuating thread 69, via the lateral housing opening 15. The threaded adapter is thus a part of the housing 10, for example an internal thread of the housing 10. An advantage of this embodiment is that the cell can have the same height during operation and be supported on its underside, such that the change in height is effected within the cell housing 10. The cell is unchanged in respect of its surroundings and is not variable in height.

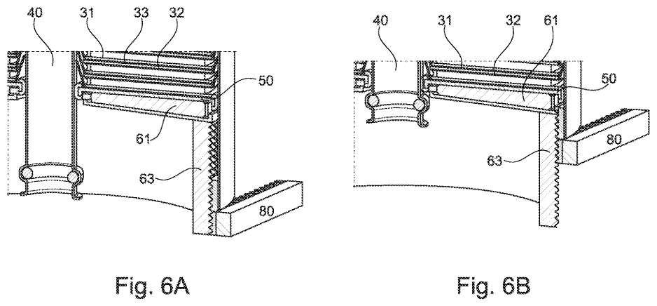

FIGS. 6A and 6B show an enlarged representation of the exemplary embodiment of an electrochemical storage cell in a charged (FIG. 6A) and a discharged state (FIG. 6B). This example corresponds to the example shown in FIGS. 1A and 1B and the exemplary embodiment described above, in the assembled state. It can be seen clearly that, in the charged state, anode layers 32 are realized, which diminish in the discharged state or, as indicated in the drawing, are no longer present at all. The resulting difference in the layer thicknesses causes the compression pressure to be adjusted. This is effected, by way of the external actuating drive 80, by turning of the screw element 63 within the threaded adapter 62, or of an internal thread of the housing 10.

Although the invention has been illustrated and described in detail with reference to exemplary embodiments, the invention is not limited by the exemplary embodiments. Rather, other variations of the invention may be derived from it by a person skilled in the art, without departure from the scope of protection of the invention as defined by the claims.

### LIST OF REFERENCE DESIGNATIONS

10 housing
11 receiving space
12 housing shell
13 cover
14 cover opening
15 housing opening
20 pressure plate
21 pressure-plate base
22 pressure-plate rim
23 pressure-plate opening
24 pressure-plate protrusion
25 insulating ring
30 electrode stack
31 cathode layer
32 anode layer
33 separator layer
34 clips
35 stack opening
40 inner tube
41 longitudinal range
42 plunger-type upper side
43 underside
44 O-ring
50 pressure plate
51 pressure-plate base
52 pressure-plate rim
53 pressure-plate opening
60 compression device
61 needle-roller and cage thrust bearing
62 threaded adapter
63 screw connection element
64 rolling-needle cage
65 rolling needles
66 rolling region
67 rotational face
68 external thread
69 lateral actuating thread
70 rotational-face opening
71 bearing openings
80 external actuating drive
SI side
S2 side

1-10. (canceled)

11. An electrochemical storage cell comprising:
an electrode stack arranged in a housing; and
a compression device for compensating an expansion of the electrode stack in a stacking direction, the compression device being configured to exert a compression pressure upon the electrode stack via rotational motion about the stacking direction, wherein
the compression pressure is adjustable depending on a rotational position, and
the electrode stack is substantially decoupled from the rotational motion of the compression device.

12. The electrochemical storage cell according to claim 11, wherein the compression device comprises:
a threaded adapter mechanically connected to the housing;
a screw connection element for setting the rotational position of the compression device, wherein the screw connection element can be screwed to the threaded adapter; and,
arranged between the electrode stack and the screw connection element, a needle-roller and cage thrust bearing configured to decouple the rotational motion about the stacking direction from the electrode stack.

13. The storage cell according to claim 12, wherein the screw connection element further has an external thread configured to engage in an internal thread of the threaded adapter, such that the screw connection element is rotatable in the threaded adapter.

14. The storage cell according to claim 12, further comprising a pressure plate, wherein the pressure plate:
is movable along the stacking direction in the housing,
rests on the needle-roller and cage thrust bearing,
is in operative mechanical contact with an underside of the electrode stack, and
is configured to exert the compression pressure upon the underside of the electrode stack.

15. The storage cell according to claim 13, wherein the needle-roller and cage thrust bearing has a rolling-needle cage and rolling needles configured to roll freely in rolling regions of the rolling-needle cage.

16. The storage cell according to claim 11, comprising a further pressure plate, wherein the further pressure plate:
is arranged mechanically fixed in the housing such that the further pressure plate is in operative mechanical contact with an upper side of the electrode stack, and
is configured to exert a counter-pressure to the compression pressure upon the upper side of the electrode stack.

17. The storage cell according to claim 11, wherein
the electrode stack comprises a stack arrangement of successive layers, and,
in a charged state, the stack arrangement comprises at least one cathode layer, at least one anode layer, and at least one separator layer arranged between the cathode layer and the anode layer.

18. The storage cell according to claim 17, wherein
the successive layers of the electrode stack are stacked in a stacking direction on an inner tube arranged in the housing, and
the at least one cathode layer and at least one anode layer are electrically contacted to the housing or to the inner tube.

19. The storage cell according to claim 12, wherein the screw connection element has a lateral actuating thread for being engaged by an external actuating drive.

20. A storage cell module comprising:
a plurality of electrochemical storage cells according to claim 11; and
at least one external actuating drive,
wherein the at least one actuating drive is configured to drive the compression device in order to exert the compression pressure upon the electrode stack and to adjust the compression pressure depending on the rotational position.
